(19) United States
(12) Patent Application Publication
(10) Pub. No.: US 2011/0264796 A1
(43) Pub. Date: Oct. 27, 2011

(54) SEARCH AND NAVIGATIONAL RATING SYSTEM FOR ONLINE SOCIAL ENVIRONMENT

(75) Inventors: Joseph Benjamin Ganetakos, Toronto (CA); John Alexander Larsen, Toronto (CA); Karl Joseph Borst, Woodbridge (CA)

(73) Assignee: GANZ, Woodbridge (CA)

(21) Appl. No.: 13/091,756

(22) Filed: Apr. 21, 2011

Related U.S. Application Data
(60) Provisional application No. 61/327,198, filed on Apr. 23, 2010.

(51) Int. Cl. G06F 15/173

(52) U.S. Cl. 709/224

(57) ABSTRACT

The subject application involves enhancing search and navigation through a social virtual environment through the use of a ratings system. The environment is comprised of smaller communities or villages. The rating of a village is determined in part by the activities performed in a village, by the user who is performing the activity, and the duration and recurrence of the activity. Another element that affects a village's current rating is the state of decline or decay to which it is subjected. Certain activities that are performed can effectively delay or negate an amount of decay to the rating, but even so, village ratings are in a continual state of decline. To increase or maintain a particular rating, village residents need to perform activities.

### CROSS-REFERENCE TO RELATED APPLICATION

This application claims the benefit of U.S. Provisional Application No. 61/327,198, entitled TRAVEL AND TOURISM RATINGS FOR ONLINE SOCIAL ENVIRONMENT and filed on Apr. 23, 2010, the entirety of which is incorporated herein by reference.

### FIELD OF THE INVENTION

This application relates generally to computer-based social environments. More specifically, this application relates to a navigational-related system and method that facilitates interaction with and navigation throughout a virtual environment.

### BACKGROUND

Once primarily used for research and shopping, the Internet has quickly become an alternative source for entertainment, dating, and multi-player gaming. Through various types of websites, virtual communities have been established that allow users to create a virtual or online reality for themselves. Computer games have also crossed over into the online world, allowing users to play against or along with each other from the comfort of their own homes, Internet cafes or other Wi-Fi outlets around the world. These online games are sometimes referred to as massively multiplayer online games (MMOG). When it comes to most online entertainment activities including MMOGs and other gaming and virtual communities, a disconnection unfortunately exists between objects in the real world and objects in the online world.

More recently, however, entertainment websites have been developed in which the website content is directly tied to a product that is purchased by a user. For example, as disclosed in U.S. Pat. No. 7,534,157 to Ganz, incorporated herein by reference in its entirety, a user purchases a toy or other real-world product that includes a hidden secret code provided in the toy packaging. Access to a certain interactive content on the website provided by the manufacturer of the toy is restricted to users who purchase a toy. When the user carries out a registration process on the manufacturer's website, which involves entering the secret code, a virtual world is presented to the user. The virtual world includes a virtual toy corresponding to the toy purchased by the user. The user can participate in various interactive activities involving the virtual toy. The user may then purchase additional toys and enter the secret codes provided with those toys to add additional virtual toys to the virtual world. These virtual toys can interact with each other, thereby enhancing the user's entertainment experiences. Despite the popularity of such websites, consumers continue to demand more interactive capabilities and more flexibility with respect to their virtual products.

### SUMMARY

The subject application involves a system and/or method which facilitates search and navigation through a social virtual environment through the use of village ratings. The rating of a village is determined in part by the activities performed in a village, by the user who is performing the activity, and the duration and recurrence of the activity. Another element that affects a village's current rating is the state of decline or decay to which it is subjected. Certain activities that are performed can effectively delay or negate an amount of decay to the rating, but even so, village ratings are in a constant state of decline. To increase or maintain a particular rating, village residents need to perform activities. The virtual environment provides a vast array of activities including games and maintenance activities to keep the villages looking attractive, clean and well-kept and to keep the villagers entertained and interacting with one another. Aside from village ratings, individual villagers can also be rated in a similar manner based on their involvement in the village and in the virtual environment in general. Villages with well-rated villagers may appear more appealing to visit by tourists (other users).

According to one aspect, a computer system for rating virtual communities is provided. The system includes a server computer system that accepts commands from a plurality of users and constructs a plurality of virtual communities on a server computer system responsive to said commands, via a computer network; said server computer system monitoring a plurality of activities performed by users within the plurality of virtual communities; said server computer system, evaluating at least one of a type, a frequency and a duration data of each of said plurality of activities and determining and assigning a respective weight to each of said plurality of activities; said server computer system calculating tourism rating values for the plurality of virtual communities based at least in part on each of said respective weights corresponding to each of the plurality of activities performed; and said server computer system returning search results for at least one of the plurality of virtual communities based at least in part on selection criteria relating to said tourism rating values.

Regarding a different aspect, a method of rating virtual communities is provided, which includes receiving input from a plurality of users via a computer network to construct a plurality of virtual communities on a server computer system; monitoring a plurality of activities performed on the plurality of virtual communities by the server computer system in response to commands received over the computer network from users; evaluating activity data, where said activity data includes at least one of a type, a frequency and a duration data of said plurality of activities using the server computer system, and determining and assigning respective weights to said plurality of activities; calculating tourism rating values by the server computer system for each of the plurality of virtual communities based at least in part on each of said respective weights and said activity data corresponding to each of the plurality of virtual communities; and in response to a search request received by the server computer system, returning search results for at least one of the plurality of communities based at least in part on selection criteria relating to said tourism rating values.

According to another aspect, a computer system for rating virtual communities is provided which includes a user computer system that communicates commands to a server computer system via a computer network in which said commands construct a plurality of virtual communities on said server computer system; said user computer communicates data corresponding to activities performed by a user within the plurality of virtual communities to said server computer system; said server computer system, evaluating at least one of a type, a frequency and a duration data of each of said plurality of activities and determining and assigning a respective weight to each of said plurality of activities; said server computer system calculating tourism rating values for the plurality of virtual communities based at least in part on each of said respective weights corresponding to each of the plurality of activities performed; and said user computer receiving search results returned from said server computer system responsive to the user's selection criteria relating to said tourism rating values, said search results include at least one of the plurality of virtual communities based at least in part on the user's selection criteria.

According to still another aspect, a method of viewing rated virtual communities is provided. This method includes communicating input from a user computer via a computer network to a server computer system to construct a plurality of virtual communities on the server computer system; submitting user commands from a user computer to the server computer system over the computer network, the commands corresponding to one or more user activities performed on the user computer; responsive to said user commands, the server computer system evaluates activity data corresponding to said user commands, where said activity data includes at least one of a type, a frequency and a duration data of said one or more user activities and determines and assigns respective weights to said one or more activities; responsive to said user commands, calculating tourism rating values by the server computer system for each of the plurality of virtual communities based at least in part on each of said respective weights and said activity data corresponding to each of the plurality of virtual communities; and communicating a search request from the user computer to the server computer system, said server computer system returning search results for at least one of the plurality of communities based at least in part on user selection criteria relating to said tourism rating values.

### BRIEF DESCRIPTION OF THE DRAWINGS

FIG. 1 is a block diagram of an exemplary system for determining travel and tourism ratings of places within a social environment to facilitate location searches through the environment.

FIG. 2 is a schematic illustration of an exemplary interface used in connection with the system of FIG. 1.

FIG. 3 is a schematic illustration of an exemplary interface used in connection with the system of FIG. 1.

FIG. 4 is a schematic illustration of an exemplary interface used in connection with the system of FIG. 1.

FIG. 5 is a schematic illustration of an exemplary interface used in connection with the system of FIG. 1.

FIG. 6 is a schematic illustration of an exemplary search interface used in connection with the system of FIG. 1.

FIG. 7 is a schematic illustration of an exemplary advanced search interface used in connection with the system of FIG. 1.

### DETAILED DESCRIPTION

Provided herein is a system and/or method for search and navigational ratings in connection to an online social or gaming environment, such as an MMOG. For example, the environment may depict a life-like setting which includes a number of small virtual communities or villages. Participants (also referred to as users or players herein) may live in a village and travel to other villages to explore or participate in activities offered in those villages. Similarly, visitors may also travel to and among the villages to explore the various environments, which may facilitate their decision of whether to join a village and fully participate in the environment. To assist in the “where should I visit” dilemma, a participant may reference a village's success. Similarly, village residents want visitors and new residents to make their home there, so increasing or maintaining a village's success is also desirable for them. There are different ways that a village's success can be measured. Its tourism rating and popularity rating are two examples. These ratings may be employed independent of one another for each village.

In particular, the tourism rating is a ranking up to n (e.g., 5) “stars” and is based on the number and/or scale of existing buildings and other structures, upgrades to the village (e.g., water features, landscaping, outdoor areas including roadways and sidewalks), and user activity within the village. User activity is a measurement of time spent by village residents and/or other visitors in the village in terms of quantity and quality of activities completed in a particular village. Absent activity within a village, the rating of a village is in a continual or calculated state of decline. Therefore, activity within that village or location should be maintained in order to maintain or increase the rating of the village. The rate of decline is either constant or otherwise calculated, and occurs when the activity in that village is too low. The tourism rating may be calculated by combining the parameters discussed above together according to a specified equation or other technique, e.g., via a lookup table.

The popularity rating is a ranking up to m “hearts,” (e.g. 5) and is determined by the number of times the village has been marked as a “Favorite” by other users. Both of these ratings support a travel graphical user interface (GUI) that can be launched from the environment's main GUI. The travel GUI allows a user participant to navigate and search through a multitude of villages or places within the environment with greater ease. In particular, it allows the user to:
Instantly travel to the user's own (resident) village;
Instantly travel to another specified village (e.g., Starter Town);
View her “Favorite” villages, visit them, and remove them from the list;
Search for a particular village; and
See a number of randomly selected villages which, for example, are organized either by star rating or heart rating.

As a further example, the system may be programmed according to an embodiment such that only the villages with a rating of 3 and higher are displayed—thus, the tourism and popularity ratings effectively determine the visibility of each village, and how likely it is to receive random visitors.

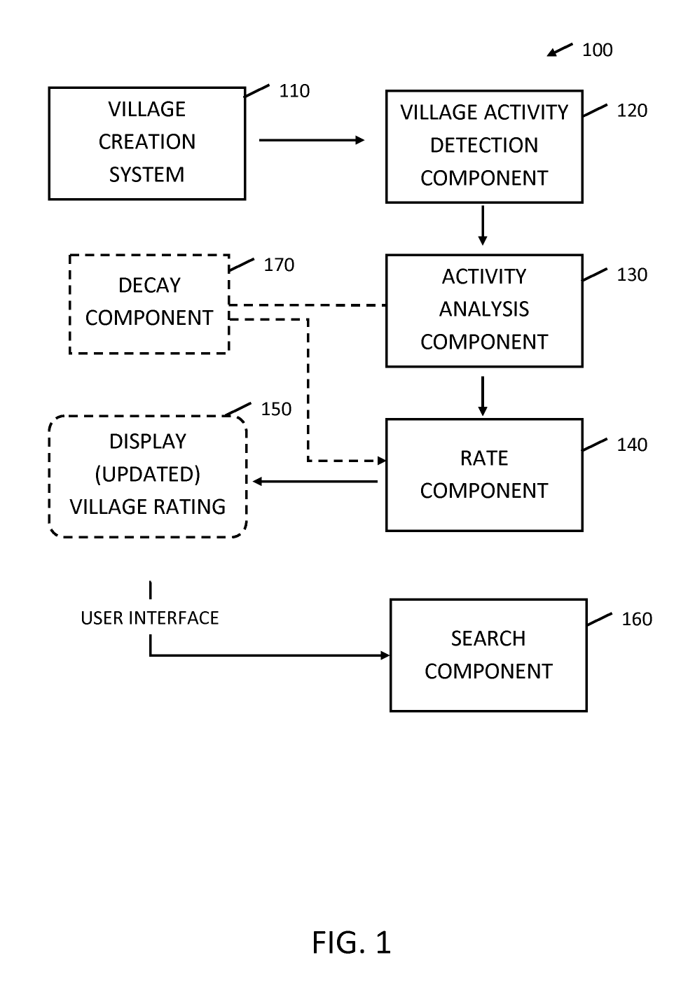

FIG. 1 is a block diagram of an exemplary system 100 that determines ratings, thereby affecting navigation through the environment. Referring to FIG. 1, the system 100 includes a village creation system 110. The village creation system 110 prepares a village in response to participants' actions in the village. For example, when a participant wants to purchase a homestead lot for a home, the village creation system 100 accesses a village database and displays lots which are available, including structure options, furnishings and the like and permits the participant to make the selections and provide payment through the use of various system components.

Once a village is established, activity within that village is monitored and identified by an activity detection component 120. The activity detection component 120 identifies the type, frequency, and duration of each activity performed. It also identifies the participant who is performing the activity (e.g., village resident, visitor, or tourist [e.g., resident to another village or not a resident of any village]). The data collected by the detection component 120 is stored in an a village activity database and communicated to an activity analysis component 130 which evaluates the type, frequency and duration data of each activity and determines the respective weight to be assigned to each activity. For example, some activities such as building a new structure or upgrading an existing structure are weighted more heavily and will influence the resulting rating determined for the village more than other activities such as buying a new piece of furniture for one's own residence or buying food at the village market.

If the same or similar activity has been performed more than once within a time frame, then the weight of that activity may decrease to a lesser value or to no value (e.g., zero value meaning that it will not affect the rating). Thus, the weight of each activity changes as more activities are performed as well as to mitigate the opportunity for a user to reverse engineer and manipulate the rating calculation. Ratings are calculated and updated immediately after an activity is completed. Alternatively, the rating can be updated at scheduled intervals of time as opposed to as soon as an activity is completed.

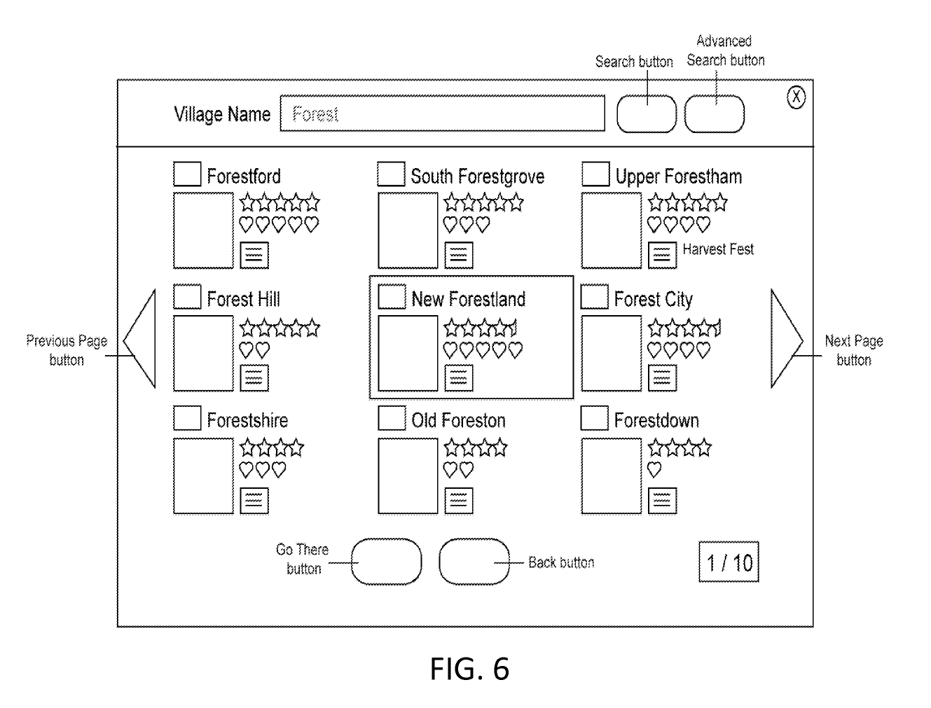

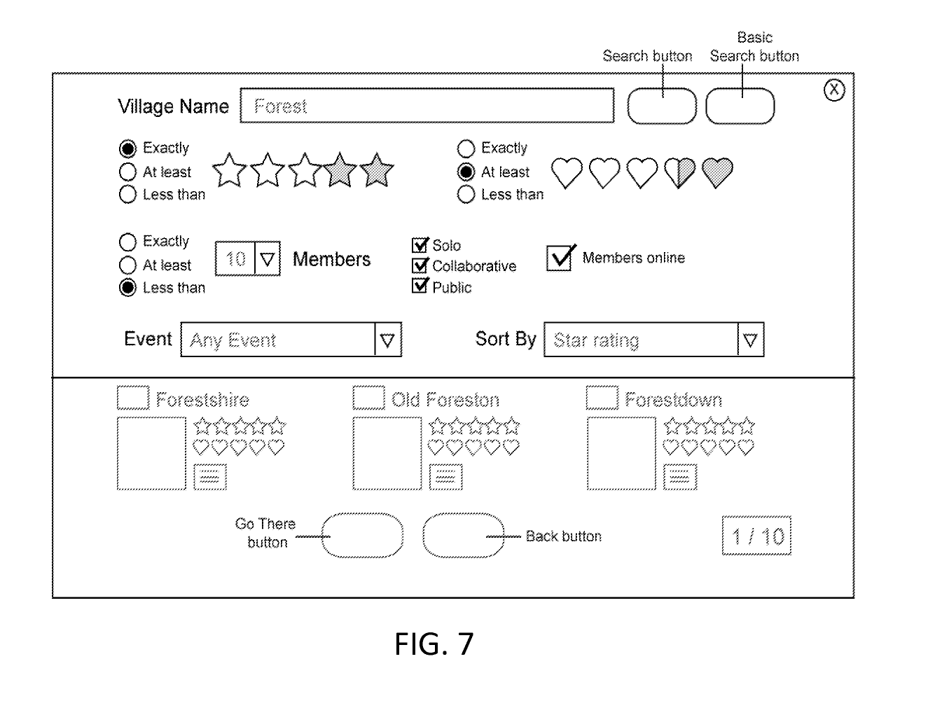

A rate component 140 receives data from the activity analysis component 130 and calculates a rating value for the village. The rating value is a numerical value on scale of 100, for instance, and is not necessarily visible to the participants in the environment. However, the rating value is translated to a smaller scale such as a star rating of up to 5 stars which is visible to the participants at 150. By way of a search GUI (see e.g., FIGS. 6 and 7), a search component 160 can include the ratings as a search parameter and display search results according to the ratings of a village. The search component 160 assists in locating places to which a participant or visitor desires to travel. Navigation through the environment including the use of the search component 160 is accomplished in part via the ratings assigned to villages at any given time. Ratings assigned to villages are not stagnant or permanent but rather are dynamic, influenced by user activity occurring directly or even indirectly in a particular village.

A village rating is also affected by a decay component 170. The decay component 170 can communicate directly with the activity analysis component 130 and/or directly with the rate component 140 to decrease the current rating value by an amount at a predetermined system rate. This causes any goodwill that is obtained to decay over time. To avoid frustrating the user, the decay component can apply its decay amount some fixed time period after the updated village rating is displayed. This way, the user can see the increase in her village rating and enjoy any benefit derived from such rating before it is subjected to the decay component 170.

The decay component 170 essentially reduces the village rating in real time. Optionally, virtual system time which runs either faster or slower than real time could also be employed. If on virtual system time, the system 100 familiarizes the user with the time scheme employed to enhance the user's experience in the virtual environment.

The amount of decay may be countered or offset by activities being performed by the user such that it appears as if there is no decrease to the rating during a particular time period—at least from the user's viewpoint. In addition, the rate of decay may decrease temporarily as a result of certain activities.

In practice, for example, each village can also have a numeric rating deemed a tourism rating that is stored by the system administrator in a database on a backend server for its use and not known by or visible to any user. In one embodiment, the tourism rating is constantly in decline, which means that the user needs to be active in her village if she wants to maintain its rating. The speed of decline is steady, so that any village's rating loses x rating value (e.g., stars) every y amount of time. In addition, the speed of decline is dynamic, as there can be certain items (such as consumable villager bonuses) that can be used to slow down the amount of time it takes for the tourism rating to decrease. With reference to the system 100, if no activity is detected by the activity detection component 120 within y amount of time, then that lack of activity or “0 data” is communicated to the activity analysis component 130 which also results in 0 data. Thus, the rate component 140 will determine a lower rating value due to the 0 activity data within y amount of time. The lower rating value results in a loss of star(s) or some portion of a star if permitted.

In some cases, the backend tourism rating is similar to or the same as the star rating that the user sees, with the exception of the rating's upper limit. In this case, each visible village rating is as high as 5 stars, with the rating increasing by increments of 0.1, 0.25, or 0.5 (so there could be a 2.5 star village, for example). However, on the backend, there can essentially be a “sixth star”, which is earned in specific ways. This means that, as far as the user is concerned, there is no difference between 5-star villages—but from a system point of view, a 5-star village with users who log on every day has a higher rating (6 stars) than one whose users are less active. The higher backend rating provides some benefits to those village residents such as a different selection of bonuses.

The lowest possible rating is essentially no rating. In one embodiment, the lowest rating actually shown may be 1 star. Generally speaking, the numerous factors contributing to the rate component's 140 calculation are weighted in various manners (via the activity analysis component 130) such that a user has the ability to readily increase her village's rating such as to 4 stars (if out of 5 stars) or to experience a rating decline to 2 stars (out of 5), for example; but it is more difficult to achieve the highest possible rating or the lowest possible rating again due to the weighting of the various factors in play. The factors largely correspond to activities or events which occur in a particular village. In the described embodiments, the visual appearance of a village rating includes a series of star-shaped icons that represent the rating. It should be understood that the item used to represent the rating can include any symbol, icon, or object that represents the rating value. With the star icon, full and half-star icons are presented and viewed in at least two ways: (1) a rollover that appears whenever the user's mouse hovers on a clickable village name. For example, if the user sees a village name in another avatar's speech bubble, the user can hover their mouse over it to see that village's rating; and (2) on the village's notice board or other general information interface. The rating is displayed in a consistent manner so that it is easily located and viewable.

The system 100 also includes a registration component that registers a physical product using a distinct code which identifies the type or name of the physical product. A real user is associated with the physical product through the registration process in which the product is essentially registered in the user's account. As a result of the registration, a virtual representation of the physical product appears on-screen in the virtual environment and the user interacts within the environment through her product's virtual representation, also referred to herein as a villager or avatar. The user controls the actions and behavior of the virtual representation of the physical product. If desired, the user can register multiple physical products using the same account and thus control multiple virtual representations in the environment.

Similar to village ratings, individual villagers or participants can also be rated in accordance with their individual activity in the virtual environment. This includes their activities performed in their resident village as well as when visiting other villages. The rating for an individual villager is determined consistent with the village rating. In particular, their activities are detected and analyzed and weighted appropriated according to the activity and according to other activities performed within the appropriate period of time. Villages with highly rated residents are displayed to represent that and are likely to appear more attractive to visitors.

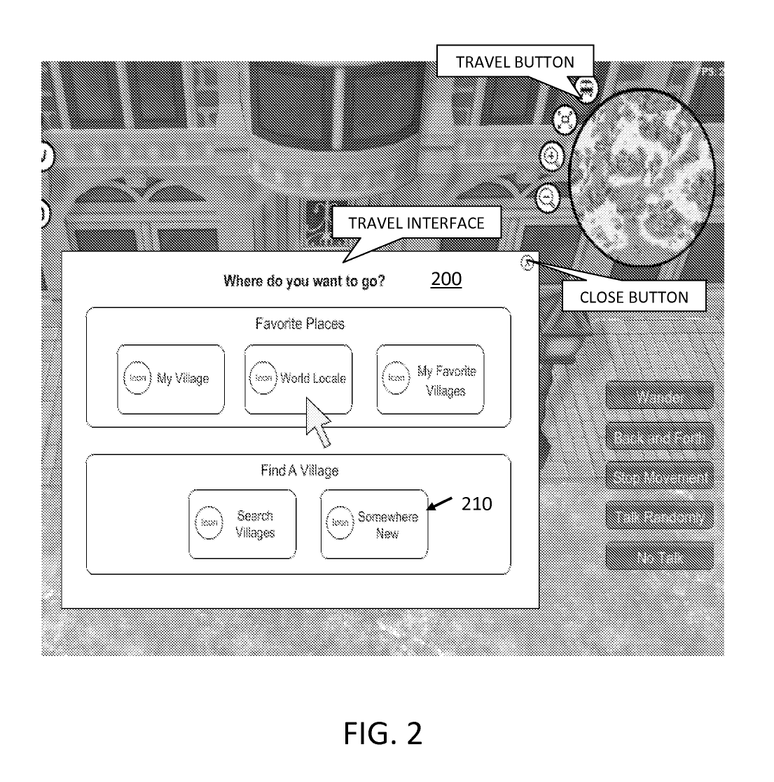

One exemplary effect of a village's tourism rating is drawing in users who make random village visits. FIG. 2 represents a schematic illustration of a travel interface 200. In particular, under a “travel” option on the GUI, the user is able to choose to be taken to somewhere new using the “Somewhere New” navigational button 210. She can then be shown the charters of 10 different villages, for instance, which are selected by the system 100. These 10 charters consist of villages with different ratings—some are “5-star” villages; some are “4-star” villages; and some are “3-star” villages. The exact number of villages displayed having 5 stars, 4, stars, or 3 stars is determined by the system 100, such as by the search component 150. It is also possible that some villages are not displayed even though they may have the same rating as others which are displayed. Further, it is also possible that some villages with lower ratings including those with 3 stars are not displayed via the “Somewhere New” request. However, preferably, the lower rated places are shown less often/frequently than the higher rated places. The system 100 may also round ratings down so that a 3½ star rated village may appear as a 3-star rated village.

At the upper end of the ratings, it is possible for a 6-star rated village to fill in a 5-star slot, meaning that “5-star” and “6-star” villages are considered to be equal for the “Somewhere New” request. Apart from this, villages with the same rating have about the same chance of being selected.

As outlined above, a village's tourism rating is in a continual state of decline. However, there can be a wide range of actions that the user can take in order to increase or maintain their village's rating. Each action can add a specific star value, which can then decay at a predetermined rate (as determined by the activity analysis component 130).

These actions affect the rating almost immediately or instantaneously; so if the user places a new building, for example, that villager can be able to see their village's updated star rating right away.

For new start-up villages, a base rating is assigned (e.g., 2½ stars). This means that a brand new village will not show up in random village visits right away (and likewise, the user is not overwhelmed by sudden visitors). The system can make it fairly easy for the user to earn the additional star(s) (e.g., extra half-star) required to get their village listed by the search component 150 (e.g., in a Somewhere New 210 request).

There is also a bonus for having multiple avatars (e.g., village residents) in a village to encourage collaboration between users. This bonus works in a tiered fashion, so that rating values are awarded when the village reaches a specific number of avatars. For example, reaching a milestone of 4 or more avatars could translate to an increase of a half-star, while achieving the milestone of 8 or more might give a full star boost.

In addition, the bonus is awarded as soon as a village is formed if multiple participants form a village together. In one example, if 4 users start a village together, that village can automatically have a rating higher than that established by less than 4 users. Alternatively, if a single user establishes a village, and then invites 3 other users later on who join her village, the bonus is given at the time that the other users join the village.

As discussed earlier, the type of activity performed by a participant affects the rating. For example, buying and placing a building in a village can yield a higher rating value than buying a pool for the user's own home. Another factor which influences the rating is the type of building. The village activity analysis component 130 may also give greater weight to the building type. In some cases, the system administrator may want users to know how much of an activity needs to be performed in order for a full star boost. For example, a building of w type may be equal to “0.25 star”. Thus, to gain a full star increase, 4 of this type of building would need to be purchased and placed in the user's village to receive a single star increase. This is a one-time boost at the time the activity is performed. After the activity has been performed (e.g., building has been placed), the presence of the building or the historical effect of the activity gives no further tourism benefit, and the stars gained from it decline at the predetermined rate.

For each village as well as per participant, the activity analysis component 130 weighs an action or activity performed in a village and/or by a particular user in part based on the other activities that have already been performed in a given village or by a given user within a certain period of time (e.g., the current day). This means that not every action of the same type is weighed equally every time or that it contributes equally every time that it is performed within a certain period of time. For example, the first time a user buys a building for her village results in a substantial contribution to the calculated rating value (e.g., raises rating by 0.5 star). The second building bought by the same user in the same village, however, has a lesser affect on the rating value as it is weighed less. With every additional building purchased by the user for her same village, its effect on the village rating diminishes sometimes relatively quickly, whereby it is possible that no value is assessed if the exact same kind of action is repeated or performed for the second time by the user in the same village within a given amount of time. For example, there may not be a limit on the number of buildings that can be bought and placed in a particular village by a participant. However, repeating the activity even among different participants by placing more than one building in the same village contributes nothing toward the rating calculation. For example, there might be a cap of a half-star per day, and any buildings placed beyond this cannot add to the tourism rating per village.

Like buildings, other village upgrades performed by users can give a one-time tourism rating boost when they are placed. They can also be assigned a specific star value on the backend, and a similar daily limit can need to be applied. The value allocated to an activity may not change, but the weight allocated to it may differ or change depending on other factors. These factors include an assessment of the activities performed in the village within a given time period and the number of residents in the village.

As in real life, villages in the virtual environment also need to be maintained by its residents. A portion of the village rating can be reserved for the performance of maintenance of activities in that village. For example, if maintenance is performed, then that portion of the village rating is included in the rating (e.g., a ½ star). On the other hand, if it is not performed by a village resident on a daily basis, then the village rating will either decrease or not increase as much within a given time frame even if other non-maintenance activities are being performed.

Maintenance includes activities such as sweeping, watering plants, trimming hedges, trash removal, and other tasks which benefit the village as a whole. Not every village resident needs to perform maintenance on a daily basis. These activities apply to the entire village, so usually just one user in a multi-player village needs to perform some kind of daily maintenance to maintain the tourism rating for that day. However, multiple users doing maintenance in the same day can slow the rate or amount of decline—that is, it may slow the standard decline rate for a time period, but the village rating will not reach a maximum rating by performing maintenance activities alone. Maintenance activities can also give the user a chance to get a special item drop (bonus), which is not available otherwise.

The non-player character or NPC is a virtual character that corresponds directly with the player. The NPC is a 3D character whom the player sees and interacts with but is managed by the system. A user cannot set up or directly control a NPC but they can employ and interact with the NPC. The system 100 determines which NPCs are present as well as their functions or jobs they can perform.

For players who wish to spend their time in the environment partaking in activities other than village maintenance, there can be a non-player character that is programmed to perform such duties in a village can be hired to do maintenance activities. Essentially, the player is paying in-game currency to retain that player's maintenance portion of the village rating for the day. However, players can only have a chance at the special item drop if she performs the activities herself.

The user can also boost the village's tourism rating by putting items up for sale with the village vendors. Once a day, the user can add any item to any vendor's stock. This activity gets detected and analyzed for its contribution to a rating increase. It should be appreciated that further item stocking on the same day may have less or no tourism benefit. As mentioned before, repeating activities within a given time period is likely to be given less or no weight when calculating the rating following such activity. The boost to the rating by initial item stocking can decay at the normal rate, meaning that if the user stocks her shelves every day, it is possible to maintain her current rating. This helps to encourage daily participation by users and prevents a user from attempting to build up the tourism rating in advance to avoid having to participate every day.

Each event that takes place in the user's village can give a specific tourism rating boost, which lasts as long as the event itself. The boost given can be different depending on the event type. Any events happening in a village are identified on the village charter, when it is chosen as one of the 10 random villages (i.e. in the Somewhere New request). The name of the event can be displayed just below the name of the village.

In addition, the village can get a tourism rating boost for receiving regular visitors (e.g., avatars who are not residents of the village). This boost also behaves in a tiered or weighted fashion—for example, half a star might be awarded for receiving 50 or more visitors in a day, and a full star for receiving 100 or more. Any stars awarded by visitor traffic can decay at the regular rate; so if the user wants to keep the boost, the user must ensure that the village continues to receive high traffic every day. Otherwise, the decay will cause the village to lose its rating over time.

As briefly described above, there can be an invisible “sixth star” that users can earn, although it is not necessarily displayed. There are at least two ways to receive this rating. The first is by “regular” activity from all users in a multi-resident village. This works in multiplayer villages with residents who log on very frequently and perform a variety of activities. For instance, a “six star” rating can be achieved if the village is already at 5 stars, and every user logs on at least once during [x] period of time (it could be a week, five days, etc). The sixth star can decay at the normal rate, so every user would need to log in at least once during q days in order to maintain the rating.

The second way applies to an individual player village. A “six star” rating is possible for these villages by hosting an event. For example, if a 4-star village hosts an event that translates to a 2 star boost, it can achieve a “six star” rating for as long as the event lasts. If the event lasts for 2 hours (real time), then the village will have a six-star rating for those 2 hours. As a result, it may receive more visits from tourists or other random visits due to its high rating. Note that the six-star rating is not actually visible but the system 100 acknowledges the high rating and presents it in search results more frequently or in some other special manner so that it stands out due to its higher rating.

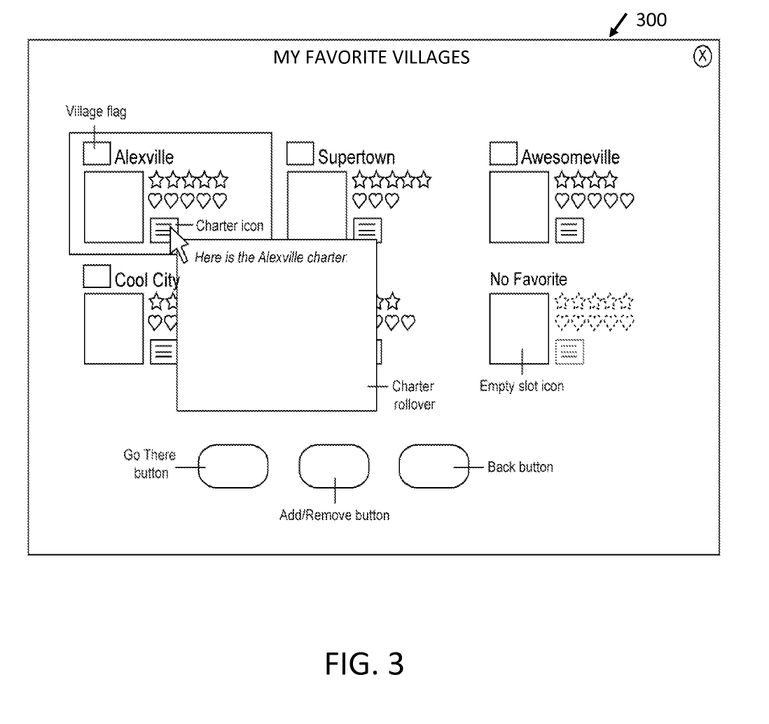

As has been described above, village ratings are dynamic and change continuously, daily or within some other designated time frame. FIGS. 3-7 depict schematic user interfaces which can be used to view information about existing villages. In FIG. 3, a “favorite villages” interface 300 is presented. A participant can mark a limited number of villages as a “favorite” and this is stored in their account. Paid users who have registered at least one physical product can include more villages in their Favorites. Those who are simply exploring the environment are restricted from full access to the various features of the environment, which includes having a lower number of villages which can be tagged as a favorite. The rate component 140 calculates a popularity rating for each village based on the number of users that have included the village in their Favorites.

For each village in this Favorites UI (user interface), the name of the village (e.g., Alexville), its ratings (e.g., tourism—stars; popularity—hearts) and its charter are viewable. This UI facilitates navigation through the environment as the user can select a “favorite” village and then select “go there” from this screen. This UI provides a brief snapshot of each village marked as a “favorite”. In one embodiment, the user is permitted to customize the information shown in addition to the name, ratings and charter icon. For instance, other icons that represent shopping, arcade, recreation, upcoming events etc. can be displayed as well to quickly indicate to the user what is available in that village.

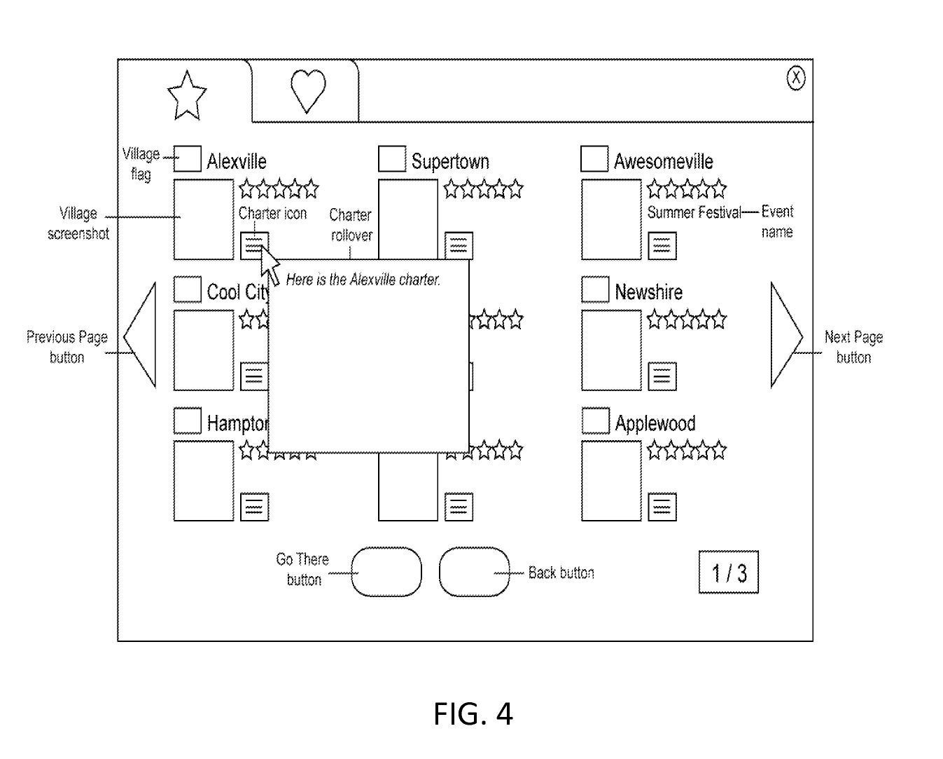

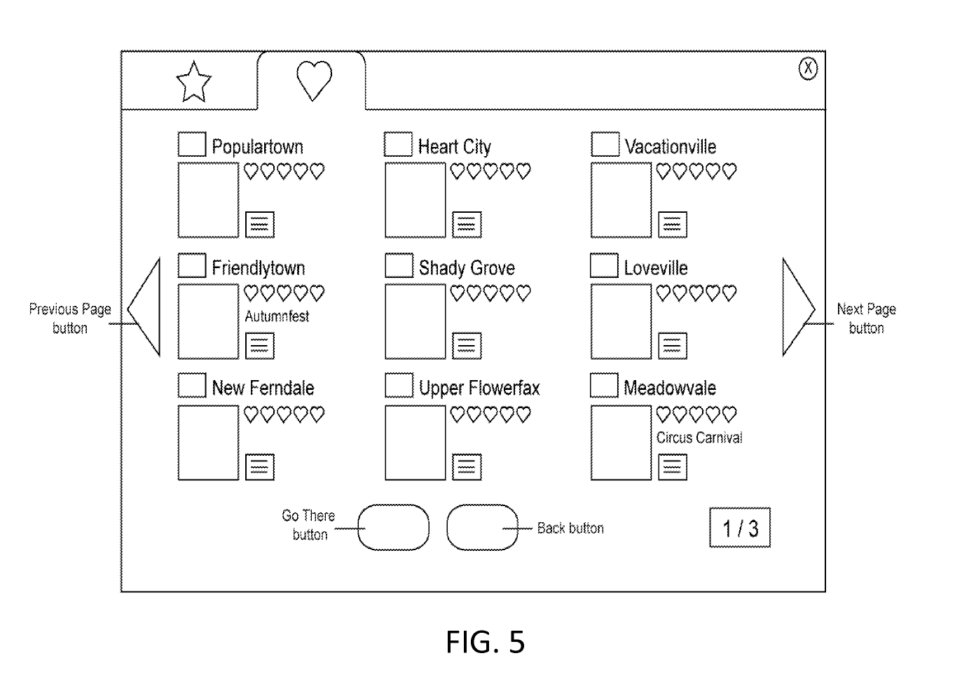

FIGS. 4 and 5 depict screens that appear as a result of a “somewhere new” request. Villages can be filtered and displayed on different tabs according to the ratings system—tourism (stars) or popularity (hearts) in these examples. Additional tabs may be set by the user as well to filter the results differently and to make searching and navigating to the desired village more efficient.

Finally, in FIGS. 6 and 7, there are shown two exemplary search UIs which can be employed by the user to view and learn information about other villages and then to quickly go there if desired. The UI in FIG. 6 represents a basic search UI as compared to the advanced search UI in FIG. 7. It should be appreciated that the information presented in these UIs are for illustrative purposes and are not exhaustive or restricted to such parameters. Other parameters may be included as well and some of those shown may be removed. For example, the popularity rating may not be included for each village.

The system 100 of FIG. 1 can be integrated into or as a part of a computer system, which is employed to generate the virtual environment to be presented to a remotely-located user operating a computing device. The computer system includes an administrative server for managing a variety of administrative tasks. For example, the administrative server can validate registration information associated with physical products being registered by a user, the administration of user accounts, and other such administrative matters.

A web server can also be included as part of the computer system. The web server can host a website comprising the virtual environment as well as other features that are to appear within the virtual environment. The web server can serve content via a communication network to at least a first computing device (e.g., end-user) as well as a second computing device, each being remotely located from the web server and from each other. The administrative server and the web server can optionally be embodied by a single terminal. The communication network can include a wide area network (“WAN”), a local area network (“LAN”), or a combination thereof. For example, the web server may communicate with the first and second computing devices in a known manner using a TCP/IP protocol over the Internet, which is an illustrative embodiment of the communication network. One or both of the computing devices can optionally be connected to the Internet via an internal gateway, router, switch, and/or any other networking devices employed to achieve the Internet connection. In one embodiment, the web server can produce output over the network as an HTML webpage based on a request.

An exemplary architecture of the computer system, particularly the administrative and web servers that collectively operate to generate the virtual environment is described as follows. A non-transitory computer-readable medium such as a hard disk drive is operable as a storage component for storing data involved in maintaining the virtual environment and other content to be served to the computing devices via the communication network. The storage component may also store computer-executable instructions that, when executed by a computer processing unit, provide for the generation and management of the virtual environment as described above.

The foregoing description includes illustrative embodiments of various aspects of the subject system and/or method. It will be apparent to those skilled in the art that the above systems and methods may incorporate changes and modifications without departing from the general scope of this invention. It is intended to include all such modifications and alterations within the scope of the subject application. Furthermore, to the extent that the term “includes” is used in either the detailed description or the claims, such term is intended to be inclusive in a manner similar to the term “comprising” as interpreted when employed as a transitional word in a claim.

What is claimed is:

1. A computer system for rating virtual communities comprising:
a server computer system that accepts commands from a plurality of users and constructs a plurality of virtual communities on a server computer system responsive to said commands, via a computer network;
said server computer system monitoring a plurality of activities performed by users within the plurality of virtual communities;
said server computer system, evaluating at least one of a type, a frequency and a duration data of each of said plurality of activities and determining and assigning a respective weight to each of said plurality of activities;
said server computer system calculating tourism rating values for the plurality of virtual communities based at least in part on each of said respective weights corresponding to each of the plurality of activities performed; and
said server computer system returning search results for at least one of the plurality of virtual communities based at least in part on selection criteria relating to said tourism rating values.

2. The computer system of claim 1, further comprising a favorite communities interface for receiving selections of favorite virtual communities from the plurality of users over the computer network, wherein the server computer system calculates a popularity rating for each of the plurality of virtual communities based on how many of the plurality of users have selected the respective one the plurality of virtual communities as a favorite virtual community.

3. The computer system of claim 2, wherein at least some of the plurality of users is limited to selecting a predetermined number of favorite communities.

4. The computer system of claim 3, wherein at least one of said plurality of users is a premium user that is not limited to selecting only said predetermined number of additional favorite communities.

5. The computer system of claim 1, wherein the server computer system comprises a maximum tourism value and a maximum visible tourism value, wherein the tourism rating value for each of the plurality of virtual communities cannot exceed the maximum tourism value, and wherein when the tourism rating value for one of the plurality of virtual communities exceeds the maximum visible tourism value then the server computer system transmits the maximum visible system value over the computer network for display on a user computer as the tourism rating value for said on of the plurality of virtual communities.

6. The computer system of claim 1, wherein the server computer system, periodically reduces the tourism rating value of each of the plurality of virtual communities by a predetermined amount.

7. A method of rating virtual communities comprising:
receiving input from a plurality of users via a computer network to construct a plurality of virtual communities on a server computer system;
monitoring a plurality of activities performed on the plurality of virtual communities by the server computer system in response to commands received over the computer network from users;
evaluating activity data, where said activity data includes at least one of a type, a frequency and a duration data of said plurality of activities using the server computer system, and determining and assigning respective weights to said plurality of activities;
calculating tourism rating values by the server computer system for each of the plurality of virtual communities based at least in part on each of said respective weights and said activity data corresponding to each of the plurality of virtual communities; and
in response to a search request received by the server computer system, returning search results for at least one of the plurality of communities based at least in part on selection criteria relating to said tourism rating values.

8. The method of claim 7, further comprising:
receiving selections of favorite virtual communities from the plurality of users over the computer network and storing the selections in a memory device by the server computer system; and
calculating a popularity rating for each of the plurality of virtual communities based on how many of the plurality of users have selected the respective one the plurality of virtual communities as a favorite virtual community.

9. The method of claim 8, wherein each of the plurality of users is limited to selecting a predetermined number of favorite communities.

10. The method of claim 9, wherein at least one of said plurality of users is a premium user that may select additional favorite communities beyond said predetermined number.

11. The method of claim 7, wherein the tourism rating value for each of the plurality of virtual communities cannot exceed a maximum tourism value, the method further comprising:
when the tourism rating value for one of the plurality of virtual communities exceeds a maximum visible tourism value, transmitting the maximum visible system value over the computer network for display on a user computer as the tourism rating value for said one of the plurality of virtual communities.

12. The method of claim 7, further comprising, using the server computer system, periodically reducing the tourism rating value of each of the plurality of virtual communities by a predetermined amount.

13. A computer system for rating virtual communities comprising:
a user computer system that communicates commands to a server computer system via a computer network in which said commands construct a plurality of virtual communities on said server computer system;
said user computer communicates data corresponding to a plurality of activities performed by a user within the plurality of virtual communities to said server computer system;
said server computer system, evaluating at least one of a type, a frequency and a duration data of each of said plurality of activities and determining and assigning a respective weight to each of said plurality of activities;
said server computer system calculating tourism rating values for the plurality of virtual communities based at least in part on each of said respective weights corresponding to each of the plurality of activities performed; and
said user computer receiving search results returned from said server computer system responsive to the user's selection criteria relating to said tourism rating values, said search results include at least one of the plurality of virtual communities based at least in part on the user's selection criteria.

14. The computer system of claim 13, further comprising a favorite communities interface displayed on the user computer for communicating selections of favorite virtual communities over the computer network to the server computer, wherein the server computer system calculates a popularity rating for each of the plurality of virtual communities based on how many of a plurality of users have selected the respective one the plurality of virtual communities as a favorite virtual community.

15. The computer system of claim 14, wherein at least some of the plurality of users is limited to selecting a predetermined number of favorite communities.

16. The computer system of claim 15, wherein at least one of said plurality of users is a premium user that is not limited to selecting only said predetermined number of additional favorite communities.

17. The computer system of claim 13, wherein the rate component comprises a maximum tourism value and a maximum visible tourism value, wherein the tourism rating value for each of the plurality of virtual communities cannot exceed the maximum tourism value, and wherein when the tourism rating value for one of the plurality of virtual communities exceeds the maximum visible tourism value then the server computer system transmits the maximum visible system value over the computer network for display on a user computer as the tourism rating value for said on of the plurality of virtual communities.

18. The computer system of claim 13, wherein the server computer system, periodically reduces the tourism rating value of each of the plurality of virtual communities by a predetermined amount.

19. A method of viewing rated virtual communities comprising:
communicating input from a user computer via a computer network to a server computer system to construct a plurality of virtual communities on the server computer system;
submitting user commands from the user computer to the server computer system over the computer network, the commands corresponding to one or more user activities performed on the user computer;
responsive to said user commands, the server computer system evaluates activity data corresponding to said user commands, where said activity data includes at least one of a type, a frequency and a duration data of said one or more user activities and determines and assigns respective weights to said one or more activities;
responsive to said user commands, calculating tourism rating values by the server computer system for each of the plurality of virtual communities based at least in part on each of said respective weights and said activity data corresponding to each of the plurality of virtual communities; and
communicating a search request from the user computer to the server computer system, said server computer system returning search results for at least one of the plurality of virtual communities based at least in part on user selection criteria relating to said tourism rating values.

20. The method of claim 19, further comprising:
communicating by a plurality of users one or more selections of favorite virtual communities over the computer network to be stored in a memory device on the server computer system, where the server computer system calculates a popularity rating for each of the plurality of virtual communities based on how many users have selected the respective one the plurality of virtual communities as a favorite virtual community.

21. The method of claim 20, wherein each of the plurality of users is limited to selecting a predetermined number of favorite communities.

22. The method of claim 21, wherein at least one of said plurality of users is a premium user that may select additional favorite communities beyond said predetermined number.

23. The method of claim 19, wherein the tourism rating value for each of the plurality of virtual communities cannot exceed a maximum tourism value, the method further comprising:
when the tourism rating value for one of the plurality of virtual communities exceeds a maximum visible tourism value, displaying the maximum visible system value on the user computer as it is transmitted from the server computer system over the computer network as the tourism rating value for said one of the plurality of virtual communities.

24. The method of claim 19, further comprising, receiving from the server computer system and displaying on the user computer an updated tourism rating value each time the server computer system periodically reduces the tourism rating value of each of the plurality of virtual communities by a predetermined amount.
